(19) United States
(12) Patent Application Publication
(10) Pub. No.: US 2008/0201009 A1
(43) Pub. Date: Aug. 21, 2008

(54) DETERMINING TOOL SET MATCHING USING PRODUCTION DATA

(75) Inventors: Andrew C. Brendler, LaGrangeville, NY (US); William K. Hoffman, Pleasant Valley, NY (US); Roger M. Young, Warwick, NY (US); Lin Zhou, LaGrangeville, NY (US)

Correspondence Address: HOFFMAN WARNICK LLC, 75 STATE ST, 14TH FL, ALBANY, NY, 12207, US

(73) Assignee: International Business Machines Corporation, Armonk, NY (US)

(21) Appl. No.: 11/675,357

(22) Filed: Feb. 15, 2007

(51) Int. Cl. G06F 19/00

(52) U.S. Cl. 700/174; 700/179

(57) ABSTRACT

A method, system and computer program product for determining matching of a tool set in a production process are disclosed. According to an embodiment, a method for determining matching of a tool set in a production process comprises: selecting a measurement step within the production process, a subset of tools of the tool set being used in the measurement step; collecting production data for each tool of the subset, the production data being related to a process feeder tool; generating a weighted average of the production data for each tool of the subset; and analyzing weighted averages of all tools of the subset using a matching standard to determine matching of the subset.

### BACKGROUND OF THE DISCLOSURE

1. Technical Field

The present disclosure relates in general to a processing system, and more particularly to determining matching of a tool set in a production process.

2. Background Art

The requirement for tool matching is becoming more critical in a processing system as technology develops over time. Conventional approaches for determining tool matching utilize monitors and special tests to collect test data, which consumes tool time and may not yield the most useful data because the monitors may not have the same measurement structures as the real products/wafers. This may lead to a condition where the production tools appear to be matched with respect to the monitors, however they are not matched in the processing of real products.

### SUMMARY

A method, system and computer program product for determining matching of a tool set in a production process are disclosed. According to an embodiment, a method for determining matching of a tool set in a production process comprises: selecting a measurement step within the production process, a subset of tools of the tool set being used in the measurement step; collecting production data for each tool of the subset, the production data being related to a process feeder tool; generating a weighted average of the production data for each tool of the subset; and analyzing weighted averages of all tools of the subset using a matching standard to determine matching of the subset.

A first aspect of the invention is directed to a method for determining matching of a tool set in a production process, the method comprising: selecting a measurement step within the production process, a subset of tools of the tool set being used in the measurement step; collecting production data for each tool of the subset, the production data being related to a process feeder tool; generating a weighted average of the production data for each tool of the subset; and analyzing weighted averages of all tools of the subset using a matching standard to determine matching of the subset.

A second aspect of the invention is directed to a system for determining matching of a tool set in a production process, the system comprising: means for selecting a measurement step within the production process, a subset of tools of the tool set being used in the measurement step; means for collecting production data for each tool of the subset, the production data being related to a process feeder tool; means for generating a weighted average of the production data for each tool of the subset; and means for analyzing weighted averages of all tools of the subset using a matching standard to determine matching of the subset.

A third aspect of the invention is directed to a computer program product determining matching of a tool set in a production process, comprising: computer usable program code which, when executed by a computer system, is configured to: select a measurement step within the production process, a subset of tools of the tool set being used in the measurement step; collect production data for each tool of the subset, the production data being related to a process feeder tool; generate a weighted average of the production data for each tool of the subset; and analyze weighted averages of all tools of the subset using a matching standard to determine matching of the subset.

Other aspects and features of the present invention, as defined solely by the claims, will become apparent to those ordinarily skilled in the art upon review of the following non-limited detailed description of the disclosure in conjunction with the accompanying figures.

### BRIEF DESCRIPTION OF THE DRAWINGS

The embodiments of this disclosure will be described in detail, with reference to the following figures, wherein like designations denote like elements, and wherein:

FIG. 1 shows a block diagram of an illustrative computer system according to an embodiment.

FIG. 2 shows an embodiment of the operation of a tool matching determining system.

FIG. 3 shows an embodiment of a process in detail.

It is noted that the drawings of the disclosure are not to scale. The drawings are intended to depict only typical aspects of the disclosure, and therefore should not be considered as limiting the scope of the disclosure. In the drawings, like numbering represents like elements among the drawings.

### DETAILED DESCRIPTION OF THE DISCLOSURE

The following detailed description of embodiments refers to the accompanying drawings, which illustrate specific embodiments of the disclosure. Other embodiments having different structures and operations do not depart from the scope of the present invention.

### 1. Computer System

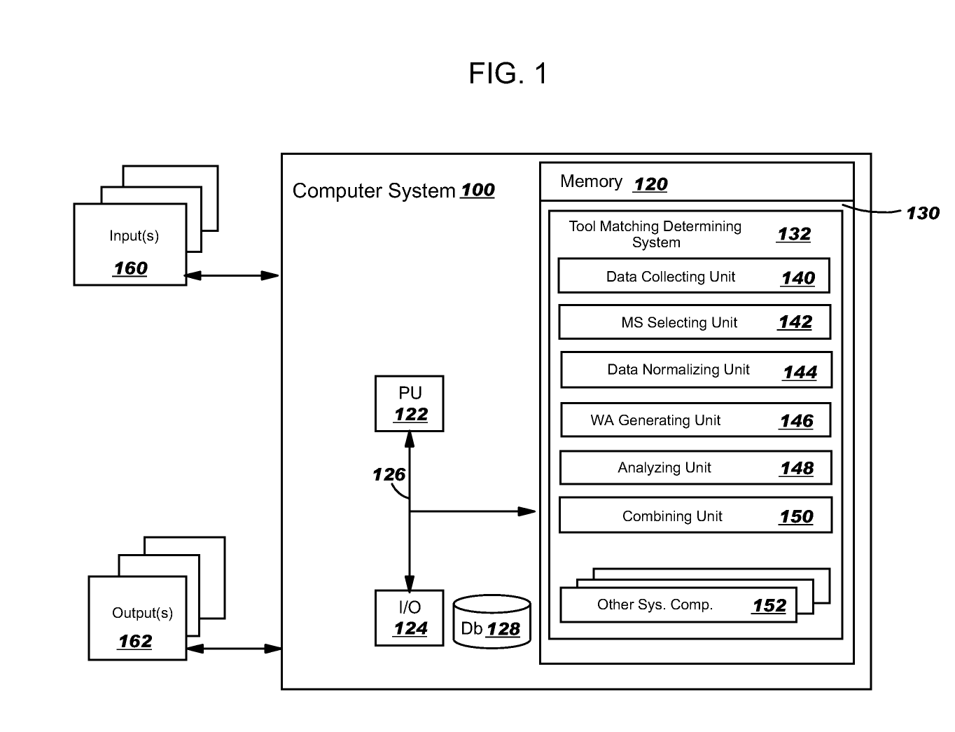

Referring to FIG. 1, a block diagram of an illustrative computer system 100 according to an embodiment of the disclosure is shown. In an embodiment, computer system 100 includes a memory 120, a processing unit (PU) 122, input/output devices (I/O) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data object, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 1, program product 130 may include a tool matching determining system 132. Tool matching determining system 132 may include a data collecting unit 140; a measurement step (MS) selecting unit 142; a data normalizing unit 144; a weighted average (WA) generating unit 146; an analyzing unit 148; a combining unit 150; and other system components 152. Other system components 152 may include any now known or later developed parts of a computer system 100 not individually delineated herein, but understood by those skilled in the art.

Inputs 160 to computer system 100 include, for example, production data of a real production process. Typically, a production process may use various tools functioning coordinately to finish the process. As such, production data of a specific tool will generally be related to other tools. In the following description, a tool under matching determination/analysis will be referred to as a “target tool” or a “tool”, and a tool coordinating with the target tool in the process will be referred to as a “process feeder tool”. It should be appreciated that a target tool and a process feeder tool are only differentiated regarding a specific tool matching determination operation. As such, a target tool can become a process feeder tool in another tool matching determination operation, and vice versa. Those inputs may be communicated to computer system 100 through I/O 124, stored in database 128, and may be collected by data collecting unit 140 in the operation of tool matching determining system 132. Outputs 162 of computer system 100 include, for example, tool matching determination results regarding a tool set, which may be communicated to, among others, a user or an automatically controlled machine to act accordingly, e.g., to replace a determined non-matching tool set. The operation of tool matching determining system 132 will be described in detail below.

### 2. Operation Methodology

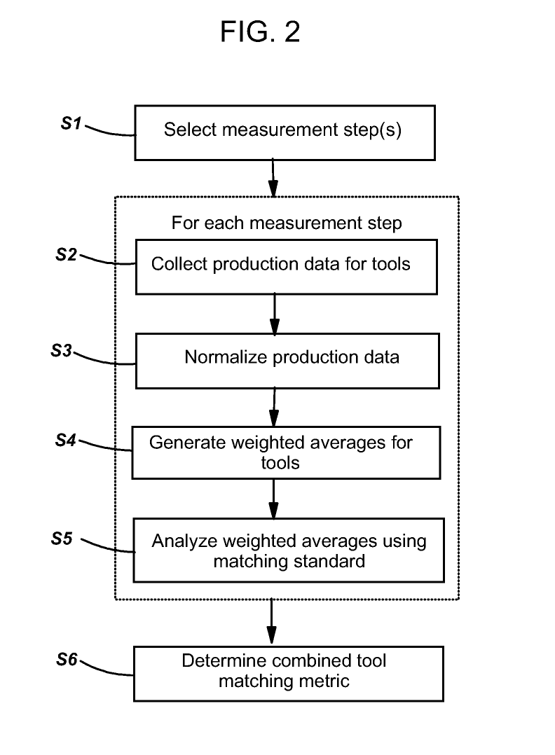

Tool matching determining system 132 functions generally to determine/evaluate matching of a tool set used in a production process. FIG. 2 shows an embodiment of the operation of tool matching determining system 132. Referring now to FIGS. 1-2, in process S1, measurement step (MS) selecting unit 142 selects a measurement step(s) within the production process for analysis. A measurement step refers to a stage in the production process that production data is collected with respect to a tool(s) in use. A subset of tools of the tool set are used in a measurement step, while different measurement steps may use different subsets of tools. Any standard may be used in selecting a measurement step and all are included in the disclosure. For example, the volume of production data of the target tool set/subsets may be used in selecting a measurement step. Specifically, a stage where the target toolset/a subset of the target tool set is used substantially (i.e., high volume of production data) will be treated as, e.g., critical for the matching of the toolset, and will be selected as a measurement step. For another example, measurement steps may need to be selected such that all the tools of the target tool set will have sufficient production data to facilitate a reliable analysis/determination of tool matching. As tool matching determining system 132 operates upon each measurement step similarly, in the following description of processes S2-S5, the operation of tool matching determining system 132 will be described regarding a specific measurement step, unless particularly indicated otherwise. As such, in the description of processes S2-S5, a tool (or a target tool) is in the subset of tools used in the specific measurement step, and a process feeder tool is one used in the specific measurement step.

In process S2, for each measurement step, data collecting unit 140 collects production data for each tool of the subset used in the measurement step. As described above, production data of a target tool is related to a process feeder tool. According to an embodiment, a process feeder tool coordinates with each and all tools of the subset in the measurement step. As such, production data of each tool of the subset includes data entries related to the same process feeder tool. According to an embodiment, in a measurement step, multiple different process feeder tools coordinate with the target subset of tools, and the collected production data of each tool includes data entries related to each process feeder tool, respectively. Table 1 shows an example of a structure of the production data collected for a subset of target tools (T1-T5) of a measurement step. T1-T5 coordinate with, e.g., three process feeder tools F1-F3 in the measurement step.

TABLE 1

| | Feeder Tool | | |
|---|---|---|---|
| Tool | F1 | F2 | F3 |
| T1 | 30 | 29 | 15 |
| T2 | 42 | 31 | 13 |
| T3 | 50 | 34 | 7 |
| T4 | 25 | 28 | 40 |
| T5 | 45 | 27 | 30 |
| Total Lots | Total lots | Total lots | Total lots |
| | processed by F1 | processed by F2 | processed by F3 |

In Table 1, each cell, e.g., T1/F1, contains a number of production data entries, each representing a “lot” processed by a combination of a target tool and a process feeder tool. For example, cell T1/F1 indicates that there are 30 lots processed by the combination of target tool T1 and process feeder tool F1, i.e., 30 target tool T1 data entries are related to process feeder tool F1.

In process S3, optionally, data normalizing unit 144 normalizes the production data related to different process feeder tools to make the data comparable among and between one another. Any method of normalization may be used and all are included in the disclosure. For example, the normalization may be implemented by subtracting each data entry of the production data of a target tool by a feeder tool average of the respective process feeder tool. As such, the influences of different process feeder tools on the production data of the target tools may be eliminated. A feeder tool average can be obtained using any method and all are included in the disclosure. According to an embodiment, a feeder tool average may be determined in two steps. First, a feeder specific mean of the production data of a target tool is calculated. A feeder specific mean of a target tool refers to a mean, e.g., a simple mean, of the target tool's production data entries that are related to a specific process feeder tool. For example, with respect to Table 1, the feeder specific mean of target tool T1 for process feeder tool F1 is the mean of all the data entries in cell T1/F1, i.e., the mean of all the tool T1 data entries that are related to process feeder tool F1. Second, a feeder tool average of a process feeder tool is calculated as a mean of all the feeder specific means related to the process feeder tool. For example, with respect to Table 1, the feeder tool average for process feeder tool F1 is the mean of the feeder specific means of cells T1/F1, T2/F1, T3/F1, T4/F1 and T5/F1. It should be appreciated that other methods of obtaining a feeder tool average may also be used. For example, a feeder tool average may be calculated as the simple mean of all production data entries related to a feeder tool average in a measurement step. For example, with respect to Table 1, the feeder tool average of process feeder tool F1 may be the mean of all data entries of cells T1/F1, T2/F1, T3/F1, T4/F1 and T5/F1.

In process S4, weighted average (WA) generating unit 146 generates a weighted average value for the production data of each tool of the subset of tools used in the measurement step. In obtaining the weighted average, any standard of assigning weight among data entries may be used, and all are included in the disclosure. With respect to Table 1, a weighted average of target tool T1 is obtained using data entries of cells T1/F1, T1/F2 and T1/F3. According to an embodiment, a weighted average is obtained by assigning more weight to a more recent data entry of the production data of a target tool. In addition, a user of tool matching determining system 132 may instruct how a weighting is assigned to a data entry through, e.g., I/O 124.

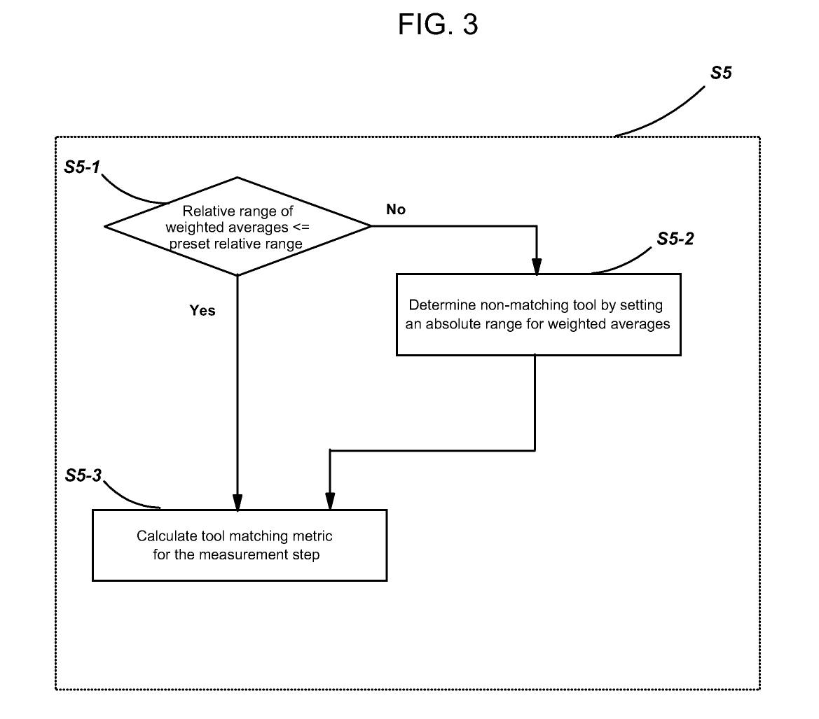

In process S5, analyzing unit 148 analyzes the weighted averages of all tools of the subset of a measurement step using a preset matching standard to determine matching of the subset. According to an embodiment, the preset standard may include a preset relative range for the weighted averages of the target tools. In this description, a relative range refers to a difference between a maximum value and a minimum value but does not include any specific value. As such, a relative range for the weighted averages only refers to a difference between a maximum weighted average value and a minimum weighted average, but does not specify either the maximum weighted average or the minimum weighted average. FIG. 3 shows an embodiment of process S5 in detail. In S5-1, analyzing unit 148 may first determine whether a relative range of the weighted averages of all tools of the subset of tools of a measurement step is within, i.e., smaller or equal to, the preset relative range. If a relative range of the weighted averages is within the preset relative range, the subset of tools are taken as matching, i.e., there is no non-matching tool, and the operation of tool matching determining system 132 goes to S5-3. If a relative range of the weighted averages is larger than the preset relative range, the operation of tool matching determining system 132 goes to S5-2, where analyzing unit 148 determines a non-matching tool(s). Specifically, analyzing unit 148 first sets an absolute range for the weighted averages. In this disclosure, an absolute range refers a range that includes a specific maximum value and a specific minimum value. The absolute range has the preset relative range, i.e., the difference between the maximum value and the minimum value of the absolute range equals to the preset relative range. The absolute range should be set such that it encloses as many weighted averages as possible. Please note that the absolute range cannot enclose all the weighted averages because the relative range of the weighted averages is larger than the preset relative range.

According to an embodiment, the absolute range may be set using the following procedures. First, the median value of the weighted averages may be selected as an initial midrange of the absolute range. As such, the absolute range may be initially set as having the preset relative range and centered at the initial midrange, i.e., the median weighted average. Then, the initial absolute range will be shifted either upward or downward to enclose as many weighted averages as possible to obtain the final absolute range. After the absolute range is set, any tool that has a weighted average outside the absolute range is determined as a non-matching tool.

In S5-3, analyzing unit 148 calculates a tool matching metric for the measurement step using formula:

TMM=(T_{sub}−Tₙₘ)/T_{sub},

where TMM denotes the tool matching metric, T_{sub} denotes a total number of tools in the subset, and Tₙₘ denotes the number of non-matching tools.

Returning to FIGS. 1-2, as mentioned above, processes S2-S5 are described regarding a specific measurement step, and the same processes may be operated upon each and every selected measurement step. The following process S6 is operated for the whole tool set.

In process S6, combining unit 150 determines a combined tool matching metric for the tool set based on tool matching metrics of all measurement steps within the production process. Any method of obtaining the combined tool matching metric can be used, and all are included in the disclosure. For example, combining unit 150 may calculate a geometric mean of the tool matching metrics of all measurement steps to be the combined tool matching metric. Matching of the whole tool set may be determined based on the combined tool matching metric.

### 3. Conclusion

While shown and described herein as a method and system for determining matching of a tool set in a production process, it is understood that the disclosure further provides various alternative embodiments. For example, in an embodiment, the disclosure provides a program product stored on a computer-readable medium, which when executed, enables a computer infrastructure to determine matching of a tool set in a production process. To this extent, the computer-readable medium includes program code, such as tool matching determining system 132 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 1) and/or database 128 (FIG. 1), and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for determining matching of a tool set in a production process, the method comprising:
selecting a measurement step within the production process, a subset of tools of the tool set being used in the measurement step;
collecting production data for each tool of the subset, the production data being related to a process feeder tool;
generating a weighted average of the production data for each tool of the subset; and
analyzing weighted averages of all tools of the subset using a matching standard to determine matching of the subset.

2. The method of claim 1, wherein the weighted average is obtained by assigning more weight to a more recent data entry of the collected production data.

3. The method of claim 1, wherein the collected production data of a tool is related to multiple different process feeder tools, respectively, the collected production data related to different process feeder tools being normalized to be comparable among and between one another.

4. The method of claim 3, wherein the normalizing includes subtracting a data entry of the collected production data by a feeder tool average of a respective process feeder tool to generate a normalized data entry.

5. The method of claim 4, wherein the feeder tool average is obtained by:
calculating a feeder specific mean of the production data related to a process feeder tool for each tool of the subset; and
calculating a mean of feeder specific means related to the process feeder tool of all tools of the subset to be the feeder tool average of the process feeder tool.

6. The method of claim 1, wherein the analyzing includes:
determining whether a relative range of the weighted averages of all the tools of the subset is within a preset relative range of the matching standard, a relative range being a difference between a maximum value and a minimum value; and
in response to the relative range of the weighted averages being larger the relative range of the matching standard, determining a non-matching tool by setting an absolute range for the weighted averages such that the absolute range encloses as many weighted averages as possible, the absolute range having the relative range of the matching standard, a tool having a weighted average outside the absolute range being determined as a non-matching tool.

7. The method of claim 6, further comprising calculating a tool matching metric for the measurement step using formula:
TMM=(T_{sub}−Tₙₘ)/T_{sub},
where TMM denotes the tool matching metric, T_{sub} denotes a total number of tools in the subset, and Tₙₘ denotes a number of non-matching tools.

8. The method of claim 7, further comprising determining a combined tool matching metric for the tool set based on tool matching metrics of all measurement steps within the production process.

9. A system for determining matching of a tool set in a production process, the system comprising:
means for selecting a measurement step within the production process, a subset of tools of the tool set being used in the measurement step;
means for collecting production data for each tool of the subset, the production data being related to a process feeder tool;
means for generating a weighted average of the production data for each tool of the subset; and
means for analyzing weighted averages of all tools of the subset using a matching standard to determine matching of the subset.

10. The system of claim 9, wherein the weighted average generating means assigns more weight to a more recent data entry of the collected production data.

11. The system of claim 9, further comprising means for normalizing the collected production data related to multiple different process feeder tools, respectively, to be comparable among and between one another.

12. The system of claim 11, wherein the normalizing subtracts a data entry of the collected production data by a feeder tool average of a respective process feeder tool to generate a normalized data entry, the feeder tool average being obtained by:
calculating a feeder specific mean of the production data related to a process feeder tool for each tool of the subset; and
calculating a mean of feeder specific means related to the process feeder tool of all tools of the subset to be the feeder tool average of the process feeder tool.

13. The system of claim 9, wherein the analyzing means:
determines whether a relative range of the weighted averages of all the tools of the subset is within a preset relative range of the matching standard, a relative range being a difference between a maximum value and a minimum value; and
in response to the relative range of the weighted averages being larger the relative range of the matching standard, determines a non-matching tool by setting an absolute range for the weighted averages such that the absolute range encloses as many weighted averages as possible, the absolute range having the relative range of the matching standard, a tool having a weighted average outside the absolute range being determined as a non-matching tool.

14. The system of claim 13, further comprising means for determining a combined tool matching metric for the tool set based on tool matching metrics of all measurement steps within the production process, a tool matching metric of a measurement step being calculated using formula:
TMM=(T_{sub}−Tₙₘ)/T_{sub},
where TMM denotes the tool matching metric, T_{sub} denotes a total number of tools in the subset, and Tₙₘ denotes a number of non-matching tools.

15. A computer program product determining matching of a tool set in a production process, comprising:
computer usable program code which, when executed by a computer system, is configured to:
select a measurement step within the production process, a subset of tools of the tool set being used in the measurement step;
collect production data for each tool of the subset, the production data being related to a process feeder tool;
generate a weighted average of the production data for each tool of the subset; and
analyze weighted averages of all tools of the subset using a matching standard to determine matching of the subset.

16. The program product of claim 15, wherein the weighted average generating is implemented by assigning more weight to a more recent data entry of the collected production data.

17. The program product of claim 15, wherein the program code is further configured to normalize the collected production data related to multiple different process feeder tools, respectively, to be comparable among and between one another.

18. The program product of claim 17, wherein the normalizing subtracts a data entry of the collected production data by a feeder tool average of a respective process feeder tool to generate a normalized data entry, the feeder tool average being obtained by:
calculating a feeder specific mean of the production data related to a process feeder tool for each tool of the subset; and
calculating a mean of feeder specific means related to the process feeder tool of all tools of the subset to be the feeder tool average of the process feeder tool.

19. The program product of claim 15, wherein the analyzing includes:
determining whether a relative range of the weighted averages of all the tools of the subset is within a preset relative range of the matching standard, a relative range being a difference between a maximum value and a minimum value; and
in response to the relative range of the weighted averages being larger the relative range of the matching standard, determining a non-matching tool by setting an absolute range for the weighted averages such that the absolute range encloses as many weighted averages as possible, the absolute range having the relative range of the matching standard, a tool having a weighted average outside the absolute range being determined as a non-matching tool.

20. The program product of claim 19, wherein the program code is further configured to determine a combined tool matching metric for the tool set based on tool matching metrics of all measurement steps within the production process, a tool matching metric of a measurement step being calculated using formula:
TMM=(T_{sub}−Tₙₘ)/T_{sub},
where TMM denotes the tool matching metric, T_{sub} denotes a total number of tools in the subset, and Tₙₘ denotes a number of non-matching tools.
